(19) United States
(12) Patent Application Publication
(10) Pub. No.: US 2004/0228225 A1
(43) Pub. Date: Nov. 18, 2004

(54) System for monitoring a telecommunication link

(76) Inventor: Ingo Thiele, Berlin (DE)

Correspondence Address: TEKTRONIX, INC., Francis I. Gray, 50-LAW, P.O. BOX 500, Beaverton, OR, 97077, US

(21) Appl. No.: 10/835,141

(22) Filed: Apr. 28, 2004

(30) Foreign Application Priority Data
May 14, 2003 (EP) 03 010 816.1

(51) Int. Cl. G11B 7/085; G06F 15/00; G11B 21/08

(52) U.S. Cl. 369/30.21

(57) ABSTRACT

A system for monitoring a telecommunication link includes a computer which has a first processor, a first connection to a host storage medium and a first system bus interface, a measurement board which has a second processor, a second system bus interface and a first line interface for linking to a telecommunication link, and a system bus with which the first system bus interface and the second system bus interface are connected. The measurement board also has a measurement storage medium and an I/O interface linking the measurement board to the second storage medium. The measurement board with the measurement storage medium and the I/O interface form an embedded system. Data acquired from the telecommunication link via the line interfaces is stored directly in the measurement storage mediums rather than being passed in realtime over a system bus to the host storage medium. The data in the measurement storage medium is subsequently passed to the computer over the system bus on a non-contentious basis for further processing.

### BACKGROUND OF THE INVENTION

The present invention relates to telecommunications system monitoring, and more particularly to a system for monitoring a telecommunication link without data loss at high bit rates.

A prior art system 10 for monitoring a telecommunication link is shown in FIG. 1. The system includes a computer 12 with a processor 14, a connection 16 to a storage medium 20 and a system bus interface 18. The system further includes measurement boards 22a, 22b, each of which includes a processor 24a, 24b, a system bus interface 26a, 26 and a line interface 28a, 28b. A system bus 30 couples the computer to the measurement boards via the respective system bus interfaces.

With this system there are from time to time several problems. For example, for the storage of data on the storage medium 20, the data arriving at the line interfaces 28a, 28b have to be transferred via the processors 24a, 24b of the respective measurement boards 22a, 22b to the processor 14 of the PC 12. If at this point in time the PC processor 14 is busy with another function, data transfer fails and the respective processors 24, 24b of the respective measurement boards 22a, 22b are occupied by this event and are therefore unavailable for other functions, such as the receipt of other data arriving at the line interfaces 28a, 28b. Moreover, data transfer from the measurement board processors 24a, 24b to the processor 14 of the PC 12 is only maximally possible at the data rate determined by the system bus 30. Also to be taken into consideration is the fact that the processor 14 of the PC 12 is usually a multi-tasking system and that other processes taking place thereon use up computing capacity which is thus not available for the recording of data received via the line interfaces 28, 28b. Conversely, the computing capacity of the processor 14 of the PC 12 is restricted by its activities as part of the measurement data acquisition, so that only a reduced computing capacity is available for other processes. These problems are furthermore aggravated by the fact that a monitoring event usually involves 4 to 8 measurement boards with at least 4 line interfaces each. An increase of the PC's computing capacity does not solve the problem because, in such a case, the other problems referred to above occur, such as the limited data rate of the system bus. For a standard system a transfer rate of, for example, 120 megabits per second on the system bus is required, but what is actually realized in most cases is approximately 80 megabits per second. This currently results in a data loss. This becomes very evident, particularly in the initialization and disconnection phases of telecommunication links.

U.S. Patent Application Publication No. 2002/0181654 discloses that real time data are stored on a host computer connected to a detector via a computer communication bus. The data are not stored by the detector that receives the data. There is no direct bus link between the detector and the data storage unit.

U.S. Patent Application Publication No. 2002/0131767 discloses a data recorder which may be designed as a recorder for an optical disk or a hard disk. This publication describes how data may be formatted and written onto a data carrier. Similar devices are disclosed in U.S. Pat. No. 6,480,666 and U.S. Pat. No. 6,377,518.

U.S. Patent Application Publication No. 2002/0027977, too, describes a system which is connected to a data recording device via a network. This means that here, too, the data recording device does not sit on the same hardware module as the data receiving device, and hence a system bus and/or a network interfaces between these two units.

U.S. Pat. No. 6,035,351 discloses a software system which interacts with a user. The user can specify parameters of his own, such as the priority of the data rate. According to these parameters the software system determines where and how a given file is written onto a hard disk.

Finally, U.S. Pat. No. 5,751,883 describes formatting multimedia data and storing multimedia data on a direct access storage system. The data are supplied by a multimedia server. There is no need to complete the data transfer in real time. Instead the data to be transmitted may be requested by the multimedia server in accordance with the recording speed of the storage system.

What is desired is a system where the storage of data arriving at the telecommunication links is possible without data loss up to bit rates that are as high as necessary.

### BRIEF SUMMARY OF THE INVENTION

Accordingly the present invention provides a system for monitoring a telecommunication link by directly assigning a measurement storage medium to a measurement board, the measurement storage medium storing data arriving via line interfaces from the telecommunication link, thus bypassing a system bus. From the measurement storage medium the data may then be passed on to a PC over the system at non-time-critical times for further processing. This solution has the advantage that only a processor on the measurement board is involved in data storage, making it unnecessary to synchronize between two processors over a system bus. Thus the bottleneck imposed by the system bus with its low data rate is bypassed. The link between the storage medium and the measurement boards is effected through an I/O bus, which allows higher data rates than the system bus. In particular, only one processor writes onto the relevant I/O bus, so that the risk of bus contention, as for example when several measurement boards try to supply data to the PC's processor at the same time, is avoided. In particular, due to the reduced number of processors connected thereto, simpler and hence faster protocols may be used on the I/O bus for data transfer. Further advantages result from the fact that the storage medium is only available for recording the data received. Accordingly, an improved monitoring of the storage space available is possible. There are no processes competing for storage space.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a block diagram view of a prior art system for monitoring a telecommunication link.

FIG. 2 is a block diagram view of a system for monitoring a telecommunication link in accordance with the present invention.

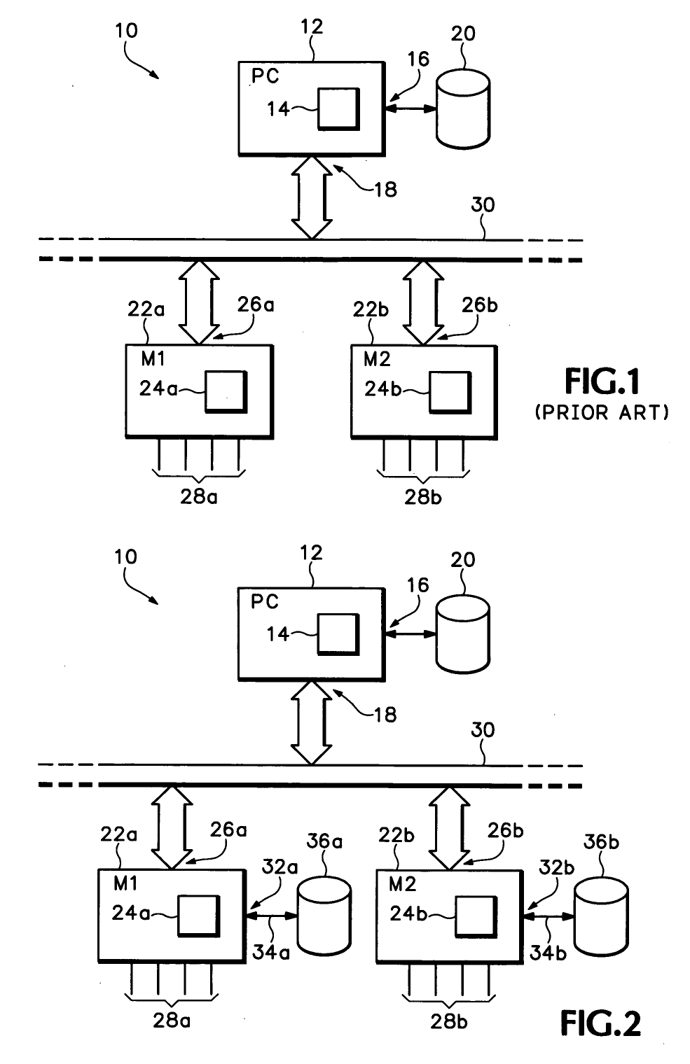

### DETAILED DESCRIPTION OF THE INVENTION

A preferred embodiment of the present invention is characterized by a measurement board being realized as a so-called embedded system. An embedded system is understood as a complete computer on a board, including a processor, an input/output (I/O) system and a random access memory (RAM). Embedded systems are not normally visible from the outside and may be found in many appliances, i.e., in a photocopier, in a television, etc. They are therefore available at favorable commercial terms.

At present, VME and compact personal computer interface (cPCI) buses are well known. Of course, the present invention is also usable with future system buses of another standard. The I/O bus is preferably realized as an ATA, an IDE, a fibre channel or a SCSI bus. Here, too the present invention may be used with future I/O buses of different standards.

In order to minimize the effort on a system featuring several measurement boards, at least two measurement boards may be linked to a common storage medium. Conversely, on a system having several measurement boards at least two measurement boards may linked to a storage medium assigned only to them. In the case of an ATA bus as the I/O bus, for example, two hard disks are connectable, while in the case of an SCSI bus as the I/O bus up to 16 disks are connectable. Thus the bit rates to be processed maximally by the system may be increased still further.

The measurement boards have two, or preferably at least four, line interfaces for linking up with telecommunication links. Each line interface is assigned a storage medium. Preferably the storage medium is a hard disk. Other storage media, such as an optical disk, a streamer, etc., may also be used. It is especially advantageous if, instead of a connection for the storage medium on the measurement board, each individual line interface is equipped with a connection for the storage medium. In this way each line interface may store its own incoming data. The measurement board is then assigned the task of making these data accessible to the PC.

Referring now to FIG. 2 each measurement board 22a, 22b has at least one I/O interface 32a, 32b to which is connected via an I/O bus 34a, 34b a hard disk 36a, 36b. Alternatively several hard disks may also be connected to the I/O bus 34a, 34b. Another variant assigns each line interface 28a, 28b to a storage medium 36a, 36b. Also several measurement boards 22a, 22b may write onto one and the same storage medium 36a, 36b.

Thus the present invention provides a system for monitoring a telecommunication link by using a measurement board as an embedded system including a processor, system interface, link interfaces and an I/O interface, the I/O interface being coupled to a storage medium such that data arriving on the link interfaces from the telecommunication link is directly stored on the storage medium rather than being transferred in realtime across a system bus via another processor to a host storage medium.

What is claimed is:

1. A system for monitoring a telecommunication link, the system being of the type having a computer which has a first processor, a first connection linking the computer to a host storage medium and a first system bus interface, a measurement board which has a second processor, a second system bus interface and a line interface for linking the measurement board to the telecommunication link, and a system bus with which the first system bus interface and the second system bus interface are linked, the system further comprising:
a measurement storage medium; and
an I/O interface for linking the measurement board directly to the measurement storage medium.

2. The system according to claim 1 wherein the measurement board comprises an embedded system which includes the measurement storage medium and the I/O interface.

3. The system according to claims 1 or 2 wherein the system bus comprises a bus selected from the group consisting of a VME bus and a cPCI bus.

4. The system according to claims 1 or 2 wherein the I/O interface comprises an I/O bus selected from the group consisting of an ATA, an IDE, a fibre channel and a SCSI bus.

5. The system according to claims 1 or 2 wherein the measurement board comprises a plurality of measurement boards linked to the measurement storage medium.

6. The system according claim 5 wherein at least two of the measurement boards are linked only to one of a plurality of measurement storage mediums.

7. The system according to claims 1 or 2 wherein the line interface comprises a plurality of line interfaces for linking the measurement board to a plurality of telecommunication links.

8. The system according to claim 7 wherein each line interface is assigned to a measurement storage medium.

9. The system according to claims 1 or 2 wherein the measurement storage medium comprises a hard disk.
